(19) United States
(12) Patent Application Publication
(10) Pub. No.: US 2014/0146804 A1
(43) Pub. Date: May 29, 2014

(54) METHOD AND DEVICE FOR OFFERING DATABASE ACCESS IN WIRELESS COMMUNICATION SYSTEM

(71) Applicants: Yongho Seok, Gyeonggi-do (KR); Eunsun Kim, Gyeonggi-do (KR); Jihyun Lee, Gyeonggi-do (KR)

(72) Inventors: Yongho Seok, Gyeonggi-do (KR); Eunsun Kim, Gyeonggi-do (KR); Jihyun Lee, Gyeonggi-do (KR)

(73) Assignee: LG ELECTRONICS INC., Seoul (KR)

(21) Appl. No.: 14/128,703

(22) PCT Filed: Jun. 27, 2012
(86) PCT No.: PCT/KR2012/005065

§ 371 Date: Jan. 23, 2014

Related U.S. Application Data
(60) Provisional application No. 61/501,257, filed on Jun. 27, 2011.
(60) Provisional application No. 61/503,624, filed on Jul. 1, 2011.

(51) Int. Cl. H04W 76/02; H04W 84/12

(52) U.S. Cl. CPC H04W 76/02; H04W 84/12
USPC 370/338

(57) ABSTRACT

The present invention relates to a wireless communication system, and more specifically, to a method and device for offering database access. According to one embodiment of the present invention, a method in which a first station (STA) accesses a database (DB) through a second STA includes the steps of: receiving a beacon or enabling signal in a first STA, operating as a dependent STA, from a second STA, operating as an enabling STA; operating a link setup of the second STA; and accessing the DB through a link with the second STA.

### TECHNICAL FIELD

The following description relates to a method of offering database access in a wireless communication system and apparatus therefor.

### BACKGROUND ART

A standard for a wireless local area network (WLAN) technology has been developed as IEEE (Institute of Electrical and Electronics Engineers) 802.11 standard. IEEE 802.11a and IEEE 802.11b use an unlicensed band in 2.4 GHz or 5 GHz, IEEE 802.11b provides transmission speed of 11 Mbps and IEEE 802.11a provides transmission speed of 54 Mbps. IEEE 802.11g provides transmission speed of 54 Mbps in a manner of applying Orthogonal Frequency Division Multiplexing (OFDM) in 2.4 GHz. IEEE 802.11n provides transmission speed of 300 Mbps for 4 spatial streams in a manner of applying Multiple Input Multiple Output-OFDM (MIMO-OFDM). IEEE802.11n supports a channel bandwidth up to 40 MHz. In this case, IEEE802.11n provides transmission speed of 600 Mbps.

Currently, ongoing effort to develop IEEE 802.11af standard has been performed. IEEE 802.11af standard is a standard set to regulate an operation of an unlicensed device in a TV whitespace (TVWS) band.

The TVWS is a frequency band assigned for a TV broadcast and includes a Very High Frequency (VHF) band (54˜60 MHz, 76˜88 MHz, 174˜216 MHz) and an Ultra High Frequency (UHF) band (470˜698 MHz). The TVWS means a frequency band permitted to an unlicensed device to use under a condition that the unlicensed device does not impede a communication of a licensed device operating in a corresponding frequency band. The licensed device can include a TV, a wireless microphone, and the like.

Although operations of all unlicensed devices are permitted on 512˜608 MHz and 614˜698 MHz except several special cases, a communication between fixed devices is only permitted on 54˜60 MHz, 76˜88 MHz, 174˜216 MHz, 470˜512 MHz. A fixed device indicates a device performing a transmission at a fixed position only. In the following description, a white space band includes the aforementioned TVWS, by which the present invention may be non-limited.

The unlicensed device wishing to use the TVWS should provide a protection function for a licensed device. Hence, the unlicensed device should check whether the licensed device occupies a corresponding band before starting a transmission in the TVWS. In particular, a use of the unlicensed device is permitted only when the licensed device is not used in the white space band.

To this end, the unlicensed device should obtain channel list information available in a corresponding region in a manner of accessing a geo-location database (GDB) via the internet or a dedicated network. The GDB is a database configured to store and manage channel usage information, which is dynamically changing in accordance with information on licensed devices registered to the GDB, geographical locations of the licensed devices, and hours of use. Moreover, such a signaling protocol as a common beacon frame and the like, a spectrum sensing mechanism, and the like can be used to solve a coexistence problem between the unlicensed devices using a white space.

In IEEE 802.11 system, a TVWS terminal may indicate an unlicensed device operating using IEEE 802.11 MAC (medium access control) layer and a PHY (physical) layer in a TVWS spectrum. Unless there is a separate explanation in the present specification, a station (STA) indicates the TVWS terminal operating in the TVWS spectrum.

The STA should provide a function of protecting an incumbent user, which corresponds to a user to which a preferential access is permitted, including a licensed user (TV, wireless microphone, and the like). In particular, if a TVWS is in use by the incumbent user, the STA should stop using a corresponding channel. Hence, the STA should operate in an available channel in a manner of searching for an available channel (i.e., a channel not used by a licensed device) capable of being used by an unlicensed device.

A method of searching for an available channel, which is searched by the STA, includes a scheme of performing a spectrum sensing mechanism, a scheme of finding out a TV channel schedule by accessing a GDB, and the like. An energy detection scheme (a scheme of judging a use of an incumbent user if a strength of a reception signal is greater than a prescribed value), a feature detection scheme (a scheme of judging a use of an incumbent user if a digital preamble is detected), and the like can be utilized as the spectrum sensing mechanism. Subsequently, the STA obtains GDB information based on location information of the STA in a manner of accessing the GDB and finds out whether a licensed device uses a channel in the corresponding location. Accessing the GDB and obtaining information should be performed with a frequency sufficient enough to protect the licensed device.

If it is judged that an incumbent user uses a channel immediately adjacent to a currently used channel, a user equipment (or STA) and a base station (or access point (AP)) can protect the incumbent user with a scheme of lowering a transmit power.

### DISCLOSURE OF THE INVENTION

### Technical Tasks

As mentioned in the foregoing description, in order for an STA to operate in a white space band, it is necessary for the STA to obtain information on an available channel in the white space band. In case of an STA (or a dependent STA) not equipped with a capability of accessing the GDB, the STA can operate in the white space band in a manner of being enabled by an STA (or enabling STA) equipped with the capability of accessing the GDB and obtaining available channel information from the STA equipped with the capability of accessing the GDB. And, it is necessary for an unlicensed device to have a format of information to efficiently search for a network and more efficiently obtain available channel information. Moreover, it is necessary for the unlicensed device to have a signaling mechanism to exchange the information.

To this end, a technical task of the present invention is to provide a method of precisely and efficiently performing a link setup between an STA not equipped with a capability of accessing the GDB and an STA equipped with the capability of accessing the GDB. Another technical task of the present invention is to provide a method of accessing the GDB in a manner that an unlicensed user not having a direct internet access indirectly obtains the internet access from a different unlicensed user.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method for accessing a database (DB) by a first station (STA) via a second STA includes receiving a beacon or an enabling signal from the second STA operating as an enabling STA by the first STA operating as a dependent STA, performing an operation of setting up a link with the second STA, and accessing the DB via the link with the second STA.

To further achieve these and other advantages and in accordance with the purpose of the present invention, according to a different embodiment, a first station (STA) device accessing a database (DB) via a second STA device includes a transceiver configured to perform transmission and reception with an external device and a processor configured to control the first STA device including the transceiver, the processor configured to receive a beacon or an enabling signal from the second STA device operating as an enabling STA by the first STA device operating as a dependent STA via the transceiver, the processor configured to perform an operation of setting up a link with the second STA device, the processor configured to access the DB via the link with the second STA device.

In the embodiments according to the present invention, following description can be commonly applied.

The first STA may obtain an available channel list for the first STA from the DB.

The first STA may correspond to an STA equipped with a geo-location capability and a DB access capability.

An internet connection may not be provided to the first STA before the link with the second STA is established.

The first STA may transmit an enabling signal to a third STA operating as a dependent STA after accessing the DB by the first STA.

The first STA may receive a channel availability query (CAQ) request from the third STA and may transmit a CAQ response request to the third STA.

The first STA may transmit a channel validity signal (CVS) to the third STA.

The third STA may correspond to an STA equipped with a geo-location capability and a DB access capability. Or, the third STA may correspond to an STA not equipped with at least one of a geo-location capability or a DB access capability.

The first STA may transmit a channel switching request to the second STA and may receive a channel switching response from the second STA.

The channel switching request may be transmitted in case that an operating channel of the second STA is not included in an available channel list of the first STA.

The channel switching request may include information on one or more candidate channels preferred by the first STA and the channel switching response may include information on a target channel determined by the second STA.

The channel switching request may include information on a target channel determined by the first STA and the channel switching response may include information indicating whether a switching to the target channel switched by the second STA is successful.

It is to be understood that both the foregoing general description and the following detailed description are exemplary and explanatory and are intended to provide further explanation of the invention as claimed.

### Advantageous Effects

According to the present invention, a method of efficiently setting up a link between devices operating in a white space band and a method of efficiently accessing a GDB can be provided.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for an example of a structure of IEEE 802.11 system to which the present invention is applicable;

FIG. 2 is a diagram for a different example of a structure of IEEE 802.11 system to which the present invention is applicable;

FIG. 3 is a diagram for a further different example of a structure of IEEE 802.11 system to which the present invention is applicable;

FIG. 4 is a diagram for an example of a structure of WLAN system;

FIG. 5 is a flowchart for explaining an example of a process of setting up a link according to one example of the present invention;

FIG. 6 (a) is a diagram for an example of a WSM;

FIG. 6 (b) is a diagram for an exemplary format of a device ID;

FIG. 6 (c) is a diagram for an exemplary format of a channel availability request frame;

FIG. 6 (d) is a diagram for an exemplary format of a channel availability response frame;

FIG. 7 is a flowchart for explaining an example of operation of a dependent STA according to the present invention;

FIG. 8 is a flowchart for explaining an example of operation of a type II device, which has no internet connection;

FIG. 9 is a flowchart for explaining an example of operation operated by a type II device as a dependent STA;

FIG. 10 is a flowchart for explaining a different example of operation of a type II device, which has no internet connection;

FIG. 11 is a diagram for an example of a case that an available channel set is different from each other according to a device;

FIG. 12 is a flowchart for explaining a channel switching request/response operation;

FIG. 13 (a) is a diagram for an example of a format of a channel switching request frame;

FIG. 13 (b) is a diagram for an example of a format of a channel switching response frame;

FIG. 14 is a block diagram for a configuration of a wireless device according to one embodiment of the present invention.

### BEST MODE

### Mode for Invention

Reference will now be made in detail to the preferred embodiments of the present invention, examples of which are illustrated in the accompanying drawings. Detailed description disclosed together with the accompanying drawings is intended to explain not a unique embodiment of the present invention but an exemplary embodiment of the present invention. In the following detailed description of the invention includes details to help the full understanding of the present invention. Yet, it is apparent to those skilled in the art that the present invention can be implemented without these details.

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be substituted with corresponding structural elements or features of another embodiment.

Specific terminologies used in the following description are provided to help the understanding of the present invention and can be modified to a different form in a scope of not deviating from the technical idea of the present invention.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same or like parts.

Embodiments of the present invention can be supported by the standard documents disclosed in at least one of IEEE 802 system, a 3GPP system, 3GPP LTE/LTE-A (LTE-Advanced), and a 3GPP2 system, which correspond to wireless access systems. In particular, steps or parts among the embodiments of the present invention, which are not explained to clearly disclose the technical idea of the present invention, can be supported by the documents. And, all terminologies disclosed in the present specification can be explained by the standard document.

The following description of embodiments of the present invention may apply to various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. For clarity, the following description mainly concerns IEEE 802.11 system, by which the technical idea of the present invention may be non-limited.

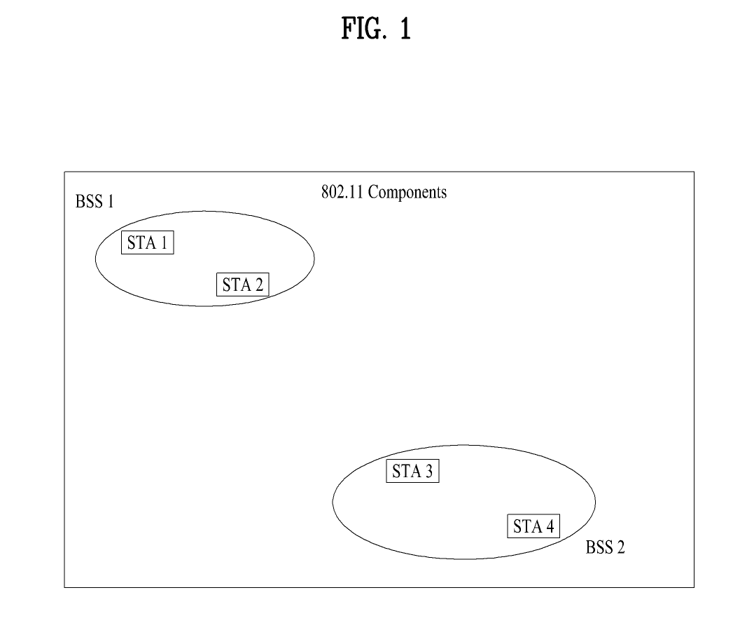

FIG. 1 is a diagram for an example of a structure of IEEE 802.11 system to which the present invention is applicable.

IEEE 802.11 structure can consist of a plurality of configuration elements and a WLAN supporting mobility of an STA, which is transparent to an upper layer, can be provided by interaction of a plurality of the configuration elements. A basic service set (hereinafter abbreviated BSS) may correspond to a basic configuration block in IEEE 802.11 LAN. FIG. 1 depicts an example that there exist two BSSs (BSS 1 and BSS 2) and two STAs are included in each of the BSSs as members, respectively (STA 1 and STA 2 are included in the BSS 1 and STA 3 and STA 4 are included in the BSS 2). An oval indicating a BSS in FIG. 1 may be comprehended as a coverage area of the STAs included in the BSS to maintain a communication. This area can be called a basic service area (hereinafter abbreviated BSA). If an STA moves out of the BSA, the STA cannot directly communicate with different STAs within the BSA.

A BSS of a most basic type in IEEE 802.11 LAN may correspond to an independent BSS (hereinafter abbreviated IBSS). For instance, the IBSS may have a minimum form consisting of two STAs only. The BSS (BSS 1 or BSS 2), which is the simplest form and omitted different configuration elements, in FIG. 1 may correspond to a representative example of the IBSS. This sort of configuration is available when the STAs are able to directly communicate with each other. And, this kind of LAN can be configured when a LAN is necessary instead of being configured in advance. Hence, this network may be called an ad-hoc network.

When power of an STA is turned on or turned off or an STA enters into a BSS area or gets out of the BSS area, a membership of the STA in a BSS can be dynamically changed. In order to be a member of the BSS, the STA can join the BSS using a synchronization process. In order to access all services based on a BSS structure, the STA should be associated with the BSS. The association can be dynamically set and may include a use of a distribution system service (hereinafter abbreviated DSS).

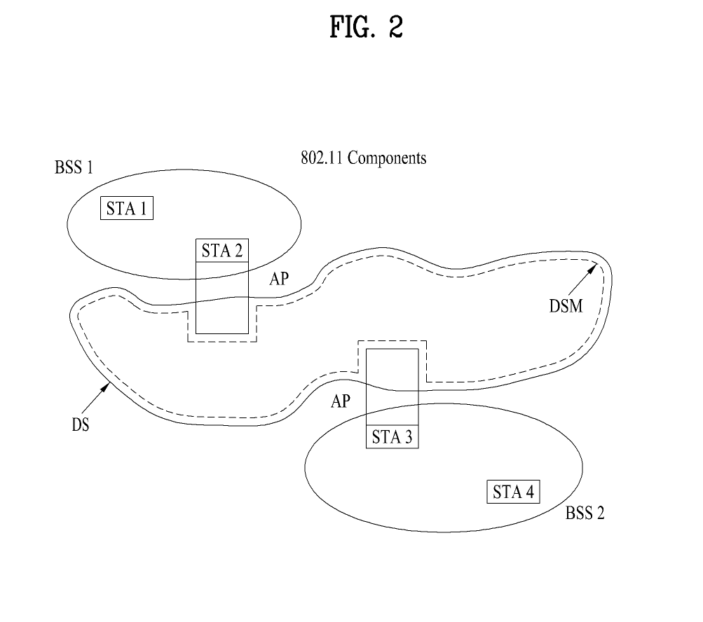

FIG. 2 is a diagram for a different example of a structure of IEEE 802.11 system to which the present invention is applicable. FIG. 2 is a form to which such a configuration element as a distribution system (DS), a distribution system medium (DMS), an access point (AP), and the like is added to the structure of FIG. 1.

In a LAN, a direct distance between stations can be restricted by PHY performance. In some cases, the distance may be sufficient to perform a communication. Yet, in some cases, it may be necessary to perform a communication of a longer distance between stations. The distribution system (DS) can be configured to support an extended coverage.

The DS means a structure that BSSs are connected with each other. Specifically, instead of independently existing as depicted in FIG. 1, a BSS may exist as a configuration element of an extended form of a network consisting of a plurality of BSSs.

The DS is a logical concept and can be characterized by an attribute of the distribution system medium (DSM). Regarding this, IEEE 802.11 standard logically distinguishes a wireless medium (WM) from the distribution system medium (DSM). Each of the logical media is used for purposes different from each other and is used by configuration elements different from each other. According to the definition of IEEE 802.11 standard, the media may be limited to neither an identical medium nor media different from each other. Flexibility of the IEEE 802.11 LAN structure can be explained in that pluralities of the media are logically different from each other. In particular, IEEE 802.11 LAN structure can be variously implemented. The corresponding LAN structure can be independently characterized by a physical attribute of each implementation example.

The DS can support a mobile device in a manner of providing the mobile device with a seamless integration of a plurality of BSSs and logical services necessary for controlling an address to a destination.

The AP enables related STAs to access the DS via the WM and means an entity having STA functionality. Data can move between the BSS and the DS via the AP. For instance, an STA 2 and an STA 3 depicted in FIG. 2 have STA functionality and provide a function of enabling the related STAs (an STA 1 and an STA 4) to access the DS. And, since all APs basically correspond to an STA, all APs are entities capable of being addressed. An address used by the AP for a communication in the WM may not be identical to an address used by the AP for a communication in the DS.

A data transmitted to an STA address of an AP from one of STAs related to the AP is always received in an uncontrolled port and can be processed by IEEE 802.1x port entity. And, if a controlled port is authenticated, a transmission data (or a frame) can be delivered to the DS.

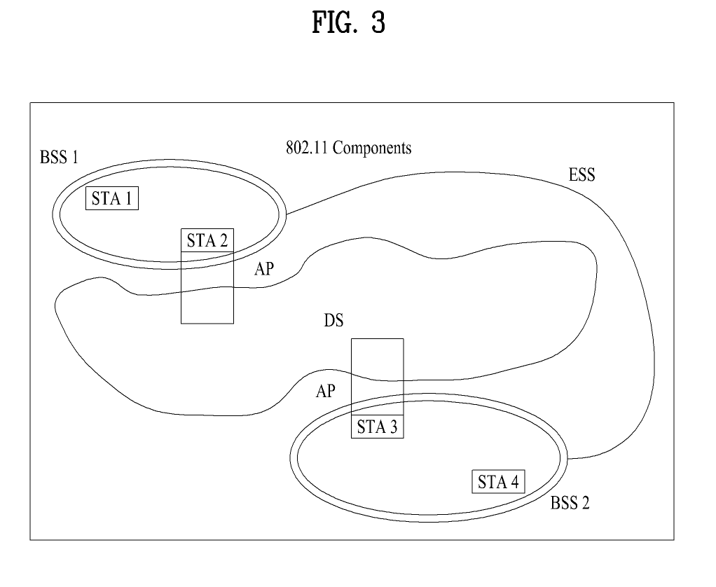

FIG. 3 is a diagram for a further different example of a structure of IEEE 802.11 system to which the present invention is applicable. FIG. 3 conceptually shows an extended service set (hereinafter abbreviated ESS) configured to provide a wider coverage in addition to the structure of FIG. 2.

A wireless network of an arbitrary size and complexity may consist of a DS and BSSs. This kind of network is called an ESS network in IEEE 802.11 system. The ESS may correspond to a set of BSSs connected with a single DS. Yet, the ESS does not include the DS. The ESS network is seen as an IBSS network in a LLC (logical link control) layer. STAs included in the ESS can communicate with each other and moving STAs can move from one BSS to another BSS (within an identical ESS) in a manner of being transparent to the LLC.

According to IEEE 802.11, nothing is assumed for a physical location of the BSSs depicted in FIG. 3. Forms described in the following are all available in IEEE 802.11. The BSSs can be partly overlapped with each other. This is a form generally used to provide a contiguous coverage. And, the BSSs may not be physically connected with each other and there is no limit for a logical distance between the BSSs. The BSSs can be physically positioned at an identical location. This can be used to provide a redundancy. And, one (or more) IBSS or ESS networks can physically exist in an identical space as one (or more) ESS network. This may correspond to a form of the ESS network in case that an ad-hoc network operates in the location at which the ESS network exists, physically duplicated IEEE 802.11 networks are configured by different organizations, two or more different access and security policies are required in an identical location, and the like.

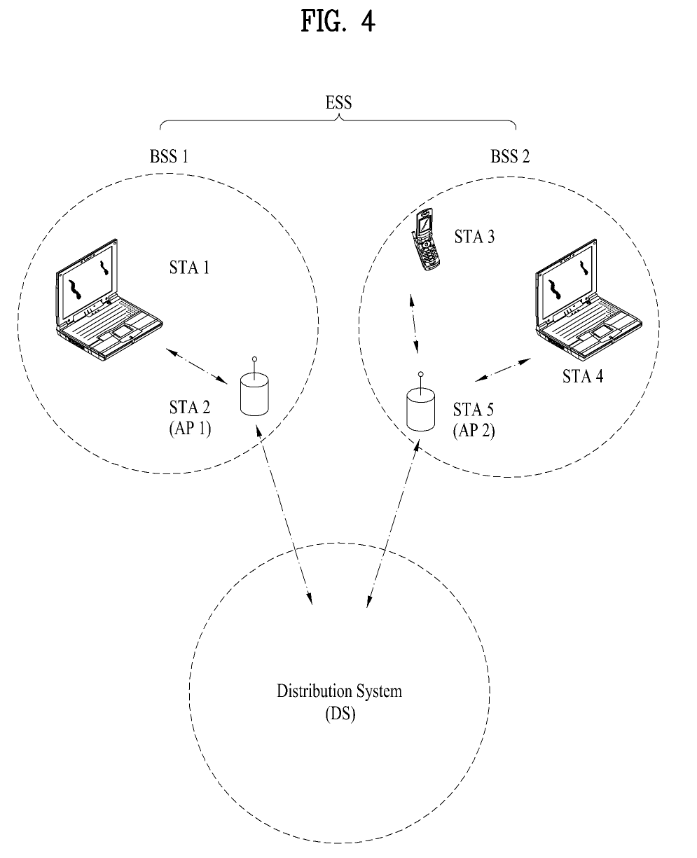

FIG. 4 is a diagram for an example of a structure of WLAN system. FIG. 4 shows an example of an infrastructure BSS including a DS.

According to the example of FIG. 4, an ESS consists of a BSS 1 and a BSS 2. In a WLAN system, an STA corresponds to a device operating in accordance with a MAC/PHY regulation of IEEE 802.11. The STA includes an AP STA and a non-AP STA. The non-AP STA corresponds to a device directly controlled by a user such as a laptop computer and a cellular phone. In the example of FIG. 4, an STA 1, an STA 3, and an STA 4 correspond to the non-AP STA and an STA 2 and an STA 5 correspond to the AP STA.

In the following description, the non-AP STA may be called a terminal, a wireless transmit/receive unit (WTRU), a user equipment (UE), a mobile station (MS), a mobile terminal (MT), a mobile subscriber station (MSS), and the like. And, the AP is a concept corresponding to a base station (BS), a node B, an evolved Node B (eNB), a base transceiver system (BTS), a femto base station (femto BS), and the like in a different wireless communication field.

### Available Channel in White Space

In order for an STA to operate in a white space, a protection scheme for a licensed device (or an incumbent user) should be preferentially provided. Hence, the STA should operate on an available channel in a manner of finding out the available channel available for an unlicensed device not used by a licensed device.

In order for the STA to identify availability of a channel (e.g., TV channel) in a white space (e.g., TVWS), the STA can figure out a TV channel schedule by performing a spectrum sensing or accessing a GDB. GDB information can include information on a schedule (i.e., time of channel use) of a specific channel use used by a licensed device in a specific location and the like. In order to identify availability of a TV channel, an STA should obtain GDB information based on a location of the STA in a manner of accessing the GDB via the internet and the like and this should be performed by a time unit sufficient enough to protect a licensed device.

For clarity, information on an available channel and frequency received from a GDB may be called a white space map (hereinafter abbreviated WSM) in the present specification. The WSM is a form of a map made of information on a channel available for an unlicensed device in a TVWS band based on information on a channel and frequency obtained from the GDB by an STA. The WSM may include information on an available channel list or frequencies usable by an unlicensed device. Channels included in the available channel list correspond to channels not used by a legally protected signal (or a user). The channels are available for an unlicensed device at the time of the access the GDB by the unlicensed device. Or, if the unlicensed device makes a request for a channel available after a specific time is passed by from the timing point of accessing the GDB, the WSM can include information on the channel or frequencies available from a corresponding timing point. As a different embodiment, if an unlicensed device makes a request for an available channel to the GDB, the GDB may deliver information on the available channel and frequencies in a manner of signaling channels unavailable for the unlicensed device.

According to a current regulation for a TVWS of FCC (federal communications commission), a device type is mainly defined by two types. In particular, one is a personal/portable device of a low power capable of being carried by a person and another one is a fixed device of a high power operating in a fixed position. The fixed device may be called a fixed STA and the personal/portable device may be called a P/P STA. Both the fixed STA and the P/P STA may correspond to a general STA (i.e., the terminology STA includes an AP and a non-AP) in a WLAN system. In case that these two types of devices operate in a TVWS, operation rules different from each other can be applied to the devices, respectively. The fixed device transmits and receives a signal at a specific position, which is fixed. Of course, in order for the fixed device to transmit a signal at the corresponding position, the fixed device should obtain available channel information by accessing the GDB as well. Although such an equipment capable of checking a position as a GPS is installed in the fixed device, position information can be delivered to the GDB in a manner that a person (i.e., an installer) directly inputs a position of the fixed device. In case that the position of the fixed device is directly inputted by the person, it is assumed that the position of the fixed device does not change after the fixed device is installed and the position of the fixed device is inputted. If the position of the fixed device changes, a new position resulted from the change should be modified and registered. The fixed device may service a different fixed device of the same kind or may service a P/P device. When the fixed device obtains available channel information from the GDB, the fixed device should receive the available channel information of the fixed device capable of being directly used by the fixed device in a manner of delivering a device type of the fixed device to the GDB. Simultaneously, in order for the fixed device to perform a service for the P/P device, available channel information capable of being used by the P/P device should be additionally received from the GDB or a proxy server connected with the GDB. Since a channel interval available for the fixed device and the channel interval available for the P/P device are different from each other and since maximum permissible transmit power and requirements for an adjacent channel of the fixed device and those of the P/P device are different from each other, an available channel list varies according to the type of each device. For instance, the fixed device is permitted to transmit a signal on a frequency band of 512˜608 MHz, 614˜698 MHz, as well as 54˜60 MHz, 76˜88 MHz, 174˜216 MHz, and 470˜512 MHz. Yet, the P/P device is not permitted to transmit a signal on a TVWS band of a different frequency band except the frequency band of 512˜608 MHz and 614˜698 MHz. And, the fixed device can transmit a signal with a high power compared to the P/P device. The maximum permissible transmit power of the fixed device is 4 Watt (EIRP (Effective Isotropically Radiated Power)).

The P/P device corresponds to a equipment capable of transceiving a signal in an unspecified position. A position of the P/P device can change. In many cases, since the P/P device corresponds to a portable device, it is difficult to predict mobility of the P/P device. An available frequency band of the P/P device corresponds to 512˜608 MHz and 614˜698 MHz and the maximum permissible transmit power of the P/P device is 100 mW (EIRP). The P/P device can be divided into 2 types (Mode I device and Mode II device) according to whether the P/P device has an identification capability for a position of the P/P device. The identification capability for the position of the P/P device means a geo-location determination capability and an access capability to the GDB via the internet access. In particular, the Mode II STA has a capability of the geo-location determination and the internet access. After information on an available channel in a position of the Mode II device is obtained by directly accessing the GDB, the Mode II device can operate in the TVWS at the position of the Mode II device. And, after the available channel information is obtained from the GDB, the Mode II device can initiate a network in a manner of transmitting a command signal (e.g., enable signal) enabling the Mode I device to start a communication. Meanwhile, the Mode I device is not required to have a capability of the geo-location determination or a capability of accessing the GDB. Instead, the Mode I device is required to operate in a manner of being controlled by the Mode II device capable of accessing the GDB and having valid available channel information or a fixed device. A P/P device corresponding to a Mode II device may service a different P/P device or the P/P device corresponding to the Mode II device may service a fixed device. In this case, the Mode II P/P device can deliver available channel information used for the fixed device to the fixed device in a manner of obtaining it from the GDB.

Meanwhile, the GDB can deliver available channel information in a position where an unlicensed device makes a request to the unlicensed device by calculating the available channel information in consideration of a schedule of channel use of such an incumbent user as a DTV, a microphone, and the like and a protection contour. Parameters considered by the GDB in case of calculating the available channel information include a device type, a position intended to be operated, transmit power, a spectrum mask, and the like. According to the FCC regulation, whether to use an adjacent channel varies depending on the device type. For instance, if a DTV currently uses a channel 30, a fixed device cannot use a channel 29 and a channel 31 although the channel 29 and the channel 31 are empty. Yet, a P/P device can use the both channels. This is because the fixed device is likely to cause interference to an adjacent channel since the fixed device has high transmit power.

For clarity, examples of the present invention are explained with reference to a TVWS as an example of a white space, by which the scope of the present invention may be non-limited. In particular, the scope of the present invention includes the examples of the present invention applied to operations in all white spaces controlled by a DB providing information on an available channel in a specific position. For instance, it is expected to permit operations of an unlicensed device controlled by the GDB in a different frequency band, which is expected to correspond to the white space in the future although it does not correspond to the white space at this moment. Hence, examples according to the principle of the present invention can be included in the scope of the present invention. Moreover, for clarity, although the present invention explains the principle of the present invention based on FCC regulations for a TVWS of which a last regulation is released, the scope of the present invention may be non-limited to an operation in the white space band according to the FCC regulations and includes examples according to the principle of the present invention in the white space band following a different regulation.

Link Setup in White Space

The present embodiment relates to a process of setting up a link in a TVWS. In particular, the present embodiment explains detail examples of a link setup between a Mode I device and a Mode II device (or a fixed device). The link setup is performed by such a process as network discovery, authentication, association, and the like. In particular, in case of the Mode I device operating in a white space band, a process of obtaining available channel information is required when a link is set up.

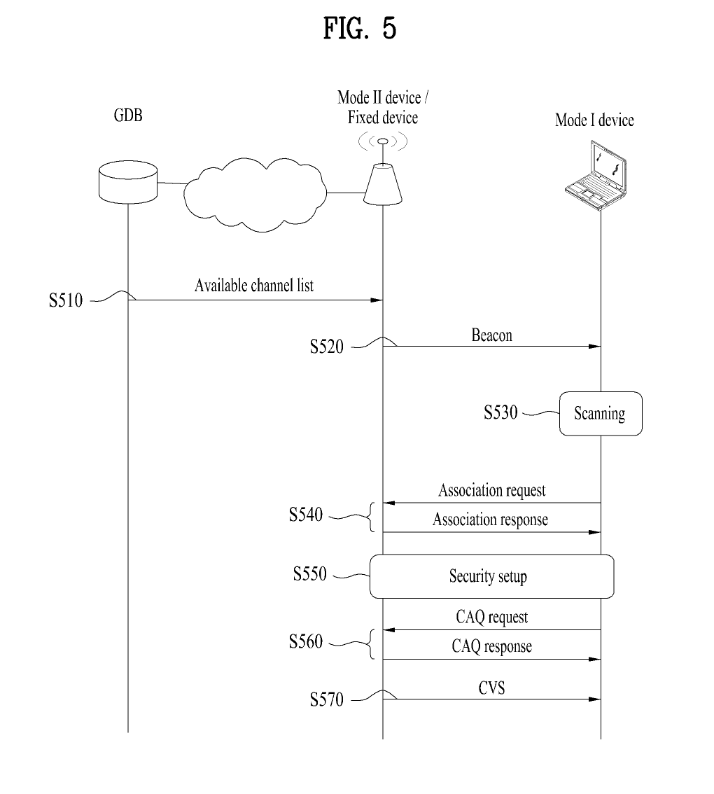

FIG. 5 is a flowchart for explaining an example of a process of setting up a link according to one example of the present invention.

In the step S510, a Mode II device or a fixed device (hereinafter represented as Mode II device/fixed device) can obtain a channel list (e.g., WSM) available in a current position of the Mode II device/fixed device by accessing the GDB via the internet and the like. The Mode II device/fixed device can select a specific channel(s) from the available channel list.

In the step S520, the Mode II device/fixed device can configure a BSS by transmitting a beacon. A beacon frame can include a device type of a transmitting side (e.g., Mode II device/fixed device) and the like and can inform a receiving side (e.g., Mode I device) that a link setup is feasible. And, the beacon frame can include information on an available channel list and the like. Moreover, the beacon frame can be periodically transmitted.

In the step S530, the Mode I device wishing to participate in a BSS can perform a scan for a TVWS. If the Mode I device knows a channel list available in a current position of the Mode I device, the Mode I device can perform a passive scan or an active scan for a channel on the available channel list only.

The passive scan means a process that the Mode I device listens a beacon transmitted by the Mode II device/fixed device on a scanning channel. The active scan means a process that the Mode I device transmits a probe request frame on the scanning channel and receives a probe response frame from the Mode II device/fixed device.

In order to reduce scanning burden of the Mode I device, the Mode II device/fixed device can include an available channel list in a beacon frame, a probe response frame, and the like. In the present invention, the available channel list obtained from the GDB by the Mode II device/fixed device may be called a WSM.

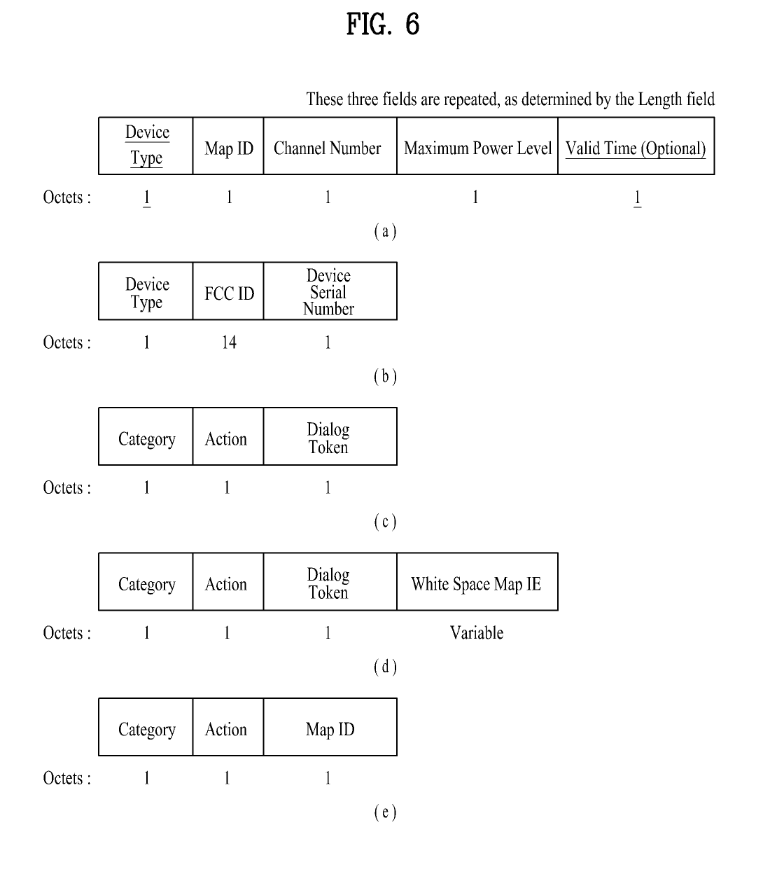

FIG. 6 (a) is a diagram for an example of a WSM.

Referring to an example of FIG. 6 (a), a device type field indicates whether a user equipment transmitting a WSM corresponds to a Mode II device or a fixed device. A Map ID field indicates an ID of an available channel list. A channel number field indicates a channel number usable by the Mode II device/fixed device in a TVWS. The channel number can be represented by a TV channel number, a spectrum range, and the like and may have a meaning as information capable of specifying an available channel in frequency domain. A maximum power level field indicates maximum transmit power of the Mode II device/fixed device in an available channel. A valid time field indicates duration capable of consistently using an available channel. The aforementioned WSM can be transmitted via a beacon frame, a probe response frame, or a frame of a different form. A format of the WSM depicted in FIG. 6 (a) is just an example only. A WSM of a different form including information on an available channel can be applied to the examples of the present invention.

In this case, in order for a Mode I device to participate in a BSS, the Mode I should operate in a manner of being controlled by the Mode II device/fixed device. Hence, the Mode I device should perform a link setup together with the Mode II device/fixed device.

In the step S540, the Mode I device can perform an association process to participate in a BSS after a scan process is completed. To this end, the Mode I device can transmit an association request frame to the Mode II device/fixed device. Table 1 in the following indicates an example of a format of the association request frame.

TABLE 1

| Order | Information | Notes |
|---|---|---|
| 1 | Capability | |
| 2 | Listen Interval | |
| 3 | SSID | |
| 4 | Supported rates | |
| 5 | Extended | The Extended Supported Rates element is present |
| | Supported | if there are more than eight supported rates, and |
| | Rates | it is optional otherwise. |
| 6 | Power | The Power Capability element is present if |
| | Capability | dot11SpectrumManagementRequired is true or |
| | | dot11RadioMeasurementActivated is true. |
| 7 | Supported | The Supported Channels element is present if |
| | Channels | dot11SpectrumManagementRequired is true and |
| | | dot11ExtendedChannelSwitchActivated is false. |
| 8 | RSN | The RSN element is present if |
| | | dot11RSNAActivated is true. |
| 9 | QoS | The QoS Capability element is present if |
| | Capability | dot11QosOption-Implemented is true. |

The Table 1 shows an example of a part of informations capable of being included in the association request frame.

According to the example of the present invention, the Mode I device can further include device ID information in the association request frame to enable the Mode II device/fixed device to check a device type of the Mode I device. By doing so, the Mode II device/fixed device checks a device ID (e.g., FCC ID, serial number, and the like) of the Mode I device, which has made a request for an association, and can judge whether the Mode I device satisfies a regulation required for a TVWS operation. After checking the device ID, the Mode II device/fixed device can transmit an association response frame to the Mode I device.

According to examples of the present invention, compared to a scheme that the Mode I device provides a device ID to the Mode II device/fixed device after all of the association processes are completed, since an operation, which follows the association process, is simplified and a device configured to transmit an association request can be identified in the middle of the association process, a link setup can be performed efficiently, promptly, and precisely.

FIG. 6 (b) is a diagram for an exemplary format of a device ID.

A device type field indicates whether a device transmitting an association request corresponds to a Mode I device or a Mode II device/fixed device. A FCC ID corresponds to a device ID value allocated by a regulatory administrator to which a device transmitting an association request belongs. A FCC ID field is a value corresponding to a device ID allocated by a regulatory administrator of the United States. The FCC ID field can be replaced with a field including appropriate device identification information in a different regulatory domain. A device serial number field can include information on a serial number (e.g., identification number allocated by a manufacturer) of a device transmitting an association request.

If a device transmitting an association request frame corresponds to a Mode II device/fixed device, a link setup process can be completed by an association request/response process only because the Mode II device/fixed device already has an available channel list (e.g., WSM) by accessing the GDB and it is not necessary to be controlled by a different Mode II device/fixed device. In particular, if the Mode II device performs the link setup process, the link setup process can be completed in the step S540.

Meanwhile, if a device transmitting an association request frame corresponds to a Mode I device, a security setup process is performed in the step S550 after an association request/response process is successfully completed. For instance, the security setup may include a process of performing a private key setup via 4-way handshaking through EAPOL (extensible authentication protocol over LAN.

The security setup should be performed between the Mode II device/fixed device and the Mode I device. This is because integrity check and the like are required when the Mode II device/fixed device delivers a WSM to the Mode I device.

In the step S560, the Mode I device can make a request for an available channel list (e.g., WSM) in a manner of transmitting a channel availability request frame (or channel availability query (CAQ) request frame) to the Mode II device/fixed device after the security setup is completed. The Mode II device/fixed device can provide the available channel list (e.g., WSM) to the Mode I device by transmitting a channel availability response frame (or CAQ response frame).

FIG. 6 (c) is a diagram for an exemplary format of a channel availability request frame and FIG. 6 (d) is a diagram for an exemplary format of a channel availability response frame.

A category field indicates a category to which a corresponding frame is belongs. In the present example, the category field can be set to a value indicating an action frame to which a channel availability request/response is belongs. An action field performs a function of indicating a corresponding frame related to a prescribed operation. In the present example, the action field can be set to a specific value for the channel availability request/response. A dialog token field performs a function of matching an action response with an action request and can be used for a case that pluralities of action requests exist at the same time. The dialog token field can include a value configured by a requesting STA (e.g., Mode I device).

The Mode I device can complete the link setup process with the Mode II device/fixed device by receiving the available channel list (e.g., WSM) via the channel availability response frame. When the link setup process is completed, the Mode I device can start to transceive data, control, management frame, and the like with the Mode II device.

As depicted in the step S570, after the link setup is completed, the Mode I device can periodically receive a CVS (contact verification signal) from the Mode II device/fixed device. The CVS may perform a function of maintaining a state of the link setup to be valid.

As depicted in an exemplary format of a CVS frame in FIG. 6 (d), a CVS transmitted from the Mode II device/fixed device can include a Map ID of a WSM possessed by the Mode II device/fixed device. Hence, the Mode I device can periodically check what is a currently valid channel and can determine the WSM, which is not indicated by a Map ID of the CVS, as invalid. In particular, when the Mode I device receives a CVS frame, the Mode I device compares the Map ID of the WSM possessed by the Mode I device with the CVS frame. If the Map ID of the WSM is different from a Map ID in the CVS frame, the Mode I device can make a request for a new available channel list (e.g. WSM) in a manner of transmitting a channel availability request frame to the Mode II device/fixed device.

In the aforementioned embodiment of the present invention, a method of efficiently and promptly performing/supporting a link setup according to a type of a device operating in a white space has been explained. In the following description, in case of an STA not equipped with a capability of directly accessing the GDB, a method of obtaining a GDB access proposed by the present invention is explained. In this case, a part or all of the contents explained for the aforementioned method of performing the link setup can be applied to contents related to a link setup in an indirect GDB access method described in the following.

Indirect GDB Access Method

In order for an unlicensed device to operate in a TVWS, the aforementioned Mode II device/fixed device should be able to check a position of the Mode II device/fixed device in a specific unit (e.g., resolution). The Mode II device/fixed device accesses a GDB of a corresponding band based on the checked position and receive information on a frequency available in the checked position, transmit power, and the like. The Mode II device/fixed device can transmit a signal to air when the aforementioned processes are completed. As mentioned in the foregoing description, since the unlicensed device operates based on a frequency band, transmit power, and the like controlled by the GDB, the unlicensed device can be called a GDC device or a GDC STA as a meaning of a device controlled (GDB-controlled) by the GDB.

Meanwhile, in order for a Mode I device or a Mode II device/fixed device not having a direct internet connection to transmit a signal in a TVWS band, it is necessary to define that signal transmission is performed after an enabling signal transmitted by the Mode II device/fixed device, which is obtained available frequency information, is received from the GDB. The enabling signal shall be described in detail later.

For clarity of explaining detail examples of the present invention, a type of an unlicensed device is defined in a manner of being classified in accordance with capability and operation of the unlicensed device in the following description. Yet, characteristic of the present invention exists not in a terminology itself of a device but in a detail operation according to a general characteristic of the device indicated by the terminology.

An unlicensed device can be divided into two types on the basis of capability of the device. First of all, a geo-location capability is capability of a device capable of checking a position of the device with a specific resolution. And, a GDB access capability is capability of a device capable of supporting a protocol, which is able to obtain available frequency information and the like by accessing a GDB. A device can be classified in accordance with whether the aforementioned two capabilities are implemented. A device including the aforementioned two capabilities is called a type II device and a device lack of at least one of the two capabilities is called a type I device. In summary, it can be shown in Table 2 as follows.

TABLE 2

| | GDB access | Geo-location | |
|---|---|---|---|
| | capability | Capability | FCC device type |
| Type II | Yes | Yes | Fixed device, |
| device | | | Personal/Portable mode II device |
| Type I | Yes | No | Personal/Portable mode I device |
| device | No | Yes | |
| | No | No | |

Table 2 shows an additional corresponding relation between a type II device/type I device defined in the present invention and a fixed device/Mode II device/Mode I device defined in FCC.

In this case, capability of GDB access of the type II device should be discriminated from a direct internet access of the type II device. In particular, although the type II device has capability of GDB access, in some cases, the type II device may access the GDB by an indirect scheme since the device does not have a direct internet access.

Meanwhile, an unlicensed device can be classified into two types on the basis of an operation (or role) of the device. A device capable of obtaining available frequency information by accessing the GDB and configuring a network by determining an operating channel may be called an enabling STA. And, a device operating in a manner of being controlled by the enabling STA may be called a dependent STA.

The enabling STA should have both the geo-location capability and the GDB access capability. And, the enabling STA should have an ability of supporting the dependent STA in a manner of transmitting an enabling signal to the dependent STA to enable the dependent STA to enter a network. In this case, the enabling signal is a signal informing that the enabling STA is able to service and access the GDB. Hence, a device capable of operating as the enabling STA corresponds to a type II device.

It is not necessary for a dependent STA to have both the geo-location capability and the GDB access capability. Hence, both a type II device and a type I device can operate as the dependent STA. Despite the type II has both the geo-location capability and the GDB access capability, the type II device can operate as the dependent STA. For instance, the type II device operates as the dependent STA when the type II device intends not to service a different STA by configuring a network or the type II device operates to obtain internet connection in a state that an internet connection for a GDB access is not set.

If a dependent STA corresponds to a type I device, the dependent STA can enter a network only after receiving an enabling signal from an enabling STA. Hence, the dependent STA should scan the enabling STA first. In this case, the scan of the dependent STA should be performed by a passive scanning (i.e., scanning via a beacon frame listening). If the dependent STA receives an enabling signal, the dependent STA can make a request for a WSM to the enabling STA (e.g., transmission of a CAQ request frame) on a corresponding channel. When the dependent STA makes a request for the WSM, the dependent STA can deliver a device ID of the dependent STA to the enabling STA at the same time. Having received the device ID of the dependent STA, the enabling STA accesses the GDB and can use the device ID of the dependent STA to check validity of the dependent STA. By doing so, the enabling STA may not provide available channel information to the dependent STA corresponding to invalid ID. The dependent STA can perform such an operation as data transmission and the like only after receiving the WSM from the enabling STA and perform such a BSS operation as AP and non-AP on an operating channel of the enabling STA. In this case, the dependent STA can periodically receive a CVS (contact verification signal) from the enabling STA. If it is judged that the WSM is updated according to whether a Map ID of the CVS is matched with a Map ID of the dependent STA, the dependent STA should make a request for the updated WSM and receive the updated WSM from the enabling STA.

The dependent STA may correspond to a type II device. Although the type II device is equipped with the geo-location capability and the GDB access capability, in some cases, one or more capabilities among the capabilities may be disabled. Similar to the type I device, the type II device may operate as a dependent STA.

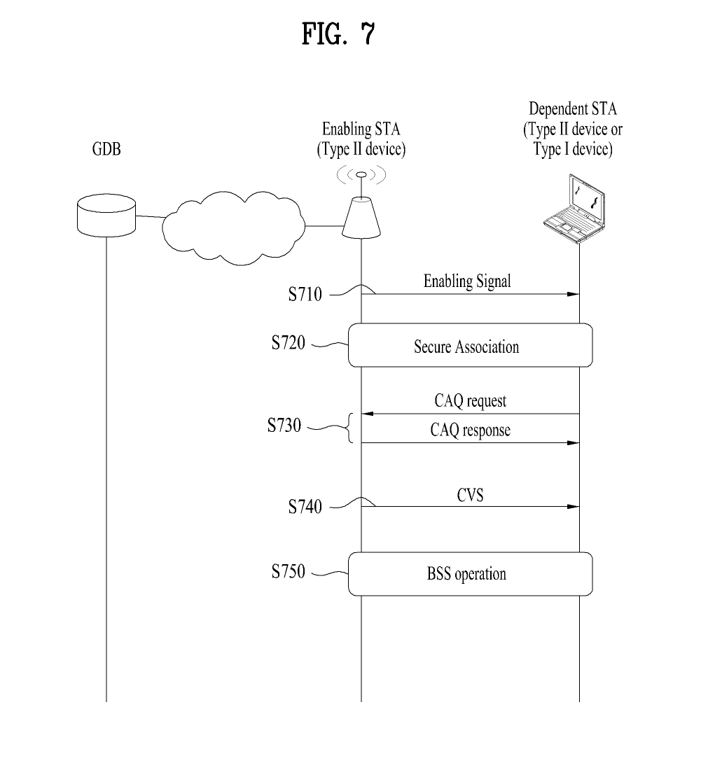

FIG. 7 is a flowchart for explaining an example of operation of a dependent STA according to the present invention.

Referring to the example of FIG. 7, a dependent STA may correspond to a type I device or a type II device of which at least one of geo-location capability and GDB access capability is disabled.

In the step S710, the enabling STA can broadcast an enabling signal to service the dependent STA.

In the step S720, secure association is a process of providing a secure communication between 2 network entities. The step S720 can include a process of exchanging of authentication, association, security related parameters (a cryptographic algorithm and mode, a traffic encryption key, a parameter on network data delivered via a connection, and the like). An STA should be authenticated before accessing a LAN in relation to an AP. The authentication provides link level identity that an STA is permitted to access a network. The association informs a DS of an AP necessary for the DS to access an STA. This is initialized in a manner that the STA makes a request for association to the AP. The STA transmits an association request management frame to the AP and the AP transmits an association response management frame to the STA in response to the association request management frame. The association request management frame provides information on STA capability, supporting channel, and the like. The association response management frame includes an association ID (AID) allocated to each request STA in addition to information on AP capability, supporting channel, and the like.

In the step S730, the enabling STA can receive a WSM request (e.g., CAQ request) including a device ID from the dependent STA. Or, as mentioned earlier in the example of FIG. 5, the device ID of the dependent STA can be provided to the enabling STA in the association operation of the step S720. Having received the device ID of the dependent STA and the WSM request from the dependent STA, the enabling STA accesses the GDB and checks validity of the device ID of the dependent STA (not depicted). If the device ID of the dependent STA is valid, the enabling STA can deliver (e.g., CAQ response) the WSM to the dependent STA. Meanwhile, if the device ID of the dependent STA is invalid, the enabling STA can notify the dependent STA that ID check has failed.

As depicted in the step S740, the enabling STA can periodically transmit a CVS to the dependent STA to make the dependent STA check validity of the WSM even after the WSM has been provided to the dependent STA. The dependent STA including a valid WSM can transceive a signal with the enabling STA on an available channel indicated by the WSM [S750].

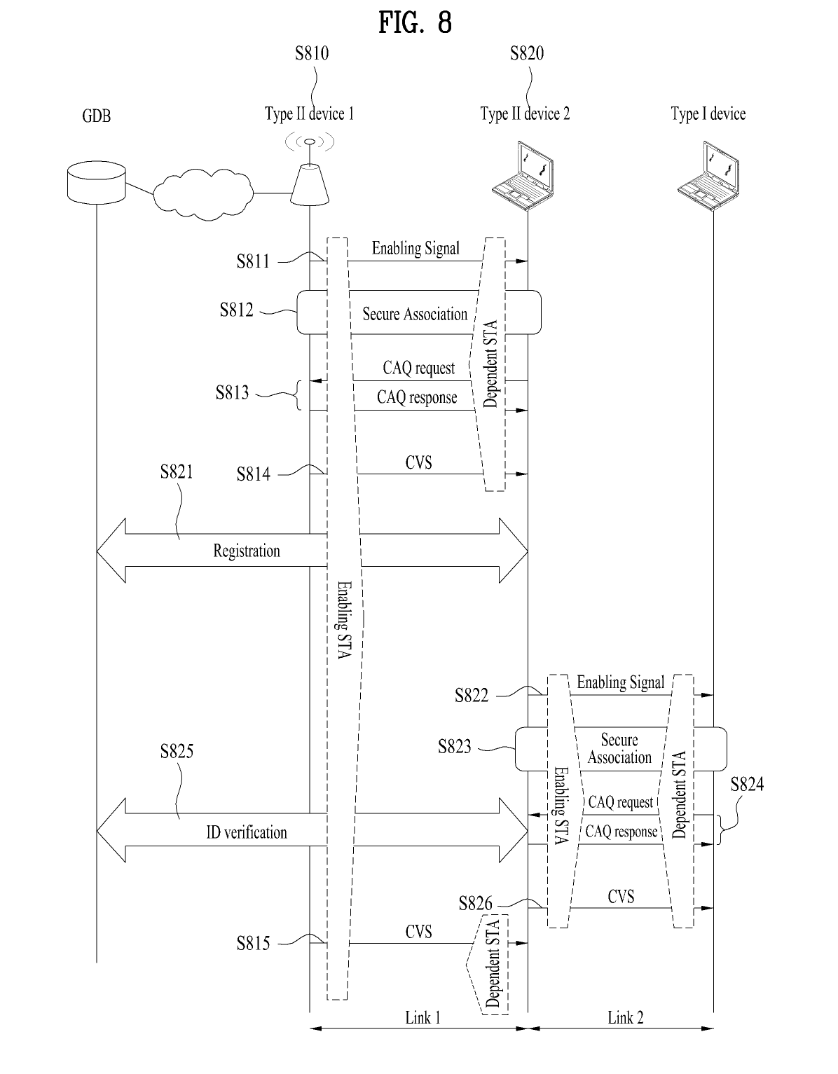

FIG. 8 is a flowchart for explaining an example of operation of a type II device, which has no internet connection. An example of FIG. 8 shows a process that a type II device, which has no internet connection, operates as an enabling STA for a different dependent STA (e.g., type I STA) in a manner of obtaining an internet connection.

In a state that an internet connection is not established, although a type II device is equipped with GDB access capability, the type II device can operate as an enabling STA since the type II device cannot access the GDB. This sort of type II device can obtain internet connection via a different type II device operating as an enabling STA. To this end, in order to set up a link to the enabling STA, the type II device of no internet connection can perform a process of setting up the link to the enabling STA in a manner of operating as a dependent STA. By doing so, the type II device, which has been operated as a dependent STA, can operate as an enabling STA after obtaining internet connection via the link to the enabling STA.

In the example of FIG. 8, assume a type II device 1 810 has direct or indirect internet connection. Hence, the type II device 1 810 can access the GDB and operate as an enabling STA. Meanwhile, assume a type II device 2 820 has no internet connection in an initial stage in FIG. 8 although the type II device 2 is equipped with GDB access capability. Hence, the type II device 2 820 cannot operate as an enabling STA but operates as a dependent STA. As depicted in the drawing, a relative role or status of STAs, which participate in connecting a link, is represented by dotted lines.

The type II device 2 820 can obtain the WSM of the type II device 1 810 from the type II device 810 via reception of an enabling signal [S811], a security association operation [S812], a CAQ request/response operation [S813], and reception of a CVS [S814]. Detail operations of step S811 to step S813 are practically identical to the operations of step S710 to step S740 explained earlier in FIG. 7. If the type II device 2 820 successfully obtains the WSM, the type II device can perform internet access via a link 1 (a link set between the type II device 1 810 and the type II device 2 820) and this is called an indirect internet connection of the type II device 2 820.

In the step S821, having obtained the indirect internet connection, the type II device 2 820 can obtain channel information available in a position of the type II device 2 from the GDB by registering position information of the type II device 2 to the GDB and querying the WSM. Having obtained the channel information available in the position of the type II device 2, the type II device 2 820 can operate as an enabling STA similar to the type II device 1 810 does. In particular, the type II device 2 820 can service a dependent STA in a manner of transmitting an enabling signal.

In the step S822 to S826, the type II device 2 820 can operate as an enabling STA for the dependent STA (i.e., the type I device). Detail operations of step S822 to step S826 are practically identical to the operations of step S710 to step S740 explained earlier in FIG. 7. In the step S825, an operation of performing ID verification performed by the type II device 2 820 may correspond to the step S730 in FIG. 7. In particular, the enabling STA (type II device 2 820), which has received the device ID of the dependent STA (i.e., the type I device) and the WSM request from the dependent STA, checks validity of the device ID of the dependent STA by accessing the GDB. Only when the device ID is valid, the enabling STA can deliver (e.g., CAQ response) the WSM to the dependent STA. By doing so, the type II device 2 820 can service the type I device in a manner of operating as the enabling STA. In FIG. 8, the link between the type II device 2 820 and the type I device is represented by a link 2.

Additionally, it is necessary for the type II device 2 820 to consistently maintain the link (i.e. link 1) with the type II device 1 810. This is because it is necessary to continuously perform a location update to the GDB when the type II device 2 820 has mobility like a P/P Mode II device does and the type II device 2 820 services the type I device while operating as an enabling STA after internet connection is obtained. For instance, in order to perform ID verification of the type I device intending to enter a network of the type II device 2 820, the link 1 is used to access the GDB. And, the link 1 is used to deliver traffic of the type I device in order to provide an internet service to the type I device. Hence, the link 1 should be consistently maintained by the type II device 2.

In order to maintain the link 1, the type II device 2 820 should periodically receive a CVS from the type II device 1 810 [S815]. If the CVS is not received within a determined time interval, the type II device 2 820 loses internet connection.

If an internet packet heading to the type I device is delivered to the type II device 2 820 via the link 1, the internet packet can be transmitted to the type I device via a link 2. Or, if an internet packet is received from the type I device via the link 2, the type II device 2 820 can deliver the internet packet to the type II device 1 810 via the link 1 and the type II device 1 810 can deliver the internet packet to a corresponding destination (or internet address). In the aforementioned operation, it can be represented as the type II device 2 820 operates as a dependent STA (for the type II device 1 810) in case of using the link 1 and the type II device 2 820 operates as an enabling STA (for the type I device) in case of using the link 2.

Meanwhile, referring to the example of FIG. 8, for the step S821 to the step S825, the type II device 2 820 operates as neither an enabling STA nor a dependent STA for the type II device 1 810. In particular, for the step S821 to the step S825, it is not necessary to define a relative relation between the type II device 2 820 and the type II device 1 810. As a different example, it may define that the type II device 2 II 820 maintains a status as a dependent STA for the type II device 1 810 for the step S821 to the step S825 (not depicted).

Subsequently, as depicted in the step S815, when the type II device 2 820 receives a CVS from the type II device 1 810, the type II device 2 820 can operate as a dependent STA for the type II device 1 810.

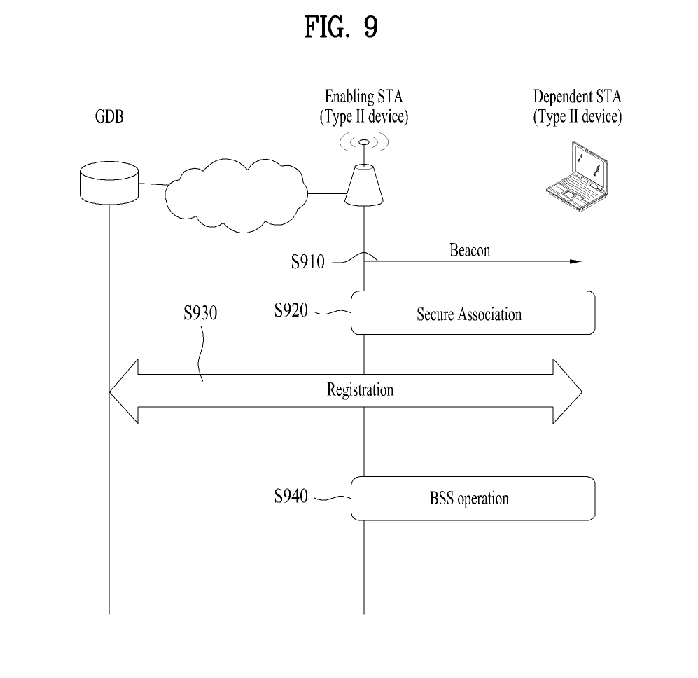

FIG. 9 is a flowchart for explaining an example of operation operated by a type II device as a dependent STA.

An operation of a type II device which is a dependent STA can be differently defined from an operation of a dependent STA explained in FIG. 7. Unlike a type I device, which is a dependent STA, mandatorily depending on an enabling STA to perform ID verification or obtain a WSM, since the type II device is equipped with geo-location capability and GDB access capability, the type II device can independently obtain the WSM and the like without depending on the enabling STA although the type II operates as a dependent STA.

In particular, in case that the type II device operates as a dependent STA to obtain and maintain internet connection, the type II device may not make a request for ID verification to an enabling STA, may not make a request for WSM to the enabling STA, or may not receive WSM update information from the enabling STA. Yet, the type II device dependent STA receives a control required for a legacy BSS operation only from the enabling STA. In the following description, operations of the type II device dependent STA are explained in detail with reference to the example of FIG. 9.

Since the type II device of no internet connection cannot access the GDB, assume a situation that the type II device operates as a dependent STA. In this case, if the dependent STA obtains a beacon from the enabling STA [S910], the dependent STA can transceive a specific management frame with the enabling STA on a channel in which the beacon is received. For instance, the specific management frame is a frame configured to perform a link setup with the enabling STA. The specific management frame can be used for a purpose of opening a L2 (second layer, e.g., MAC layer) channel between the enabling STA and the dependent STA to enable the dependent STA to access the GDB via the enabling STA. The link setup process corresponds to secure association [S920].

As mentioned in the foregoing description, since the type II device dependent STA is equipped with the geo-location capability and GDB access capability, it is not necessary for the type II device dependent STA to receive an enabling signal from the enabling STA, to deliver ID of the type II device dependent STA to the enabling STA, to obtain WSM from the enabling STA, or to periodically receive a CVS to maintain a link with the enabling STA. In particular, if a link is set via the secure association operation after the beacon is received, the type II device dependent STA obtains internet connection via the link. Yet, if necessary, the type II device dependent STA can make a request for WSM of the enabling STA to the enabling STA.

In the step S930, having obtained internet connection, the type II device (which was a dependent STA) can access authenticated GDB via the established internet connection. By doing so, the type II device can obtain information on an available channel and the like from the GDB. Meanwhile, the type II device dependent STA may receive a control required for a legacy BSS operation from the enabling STA [S940].

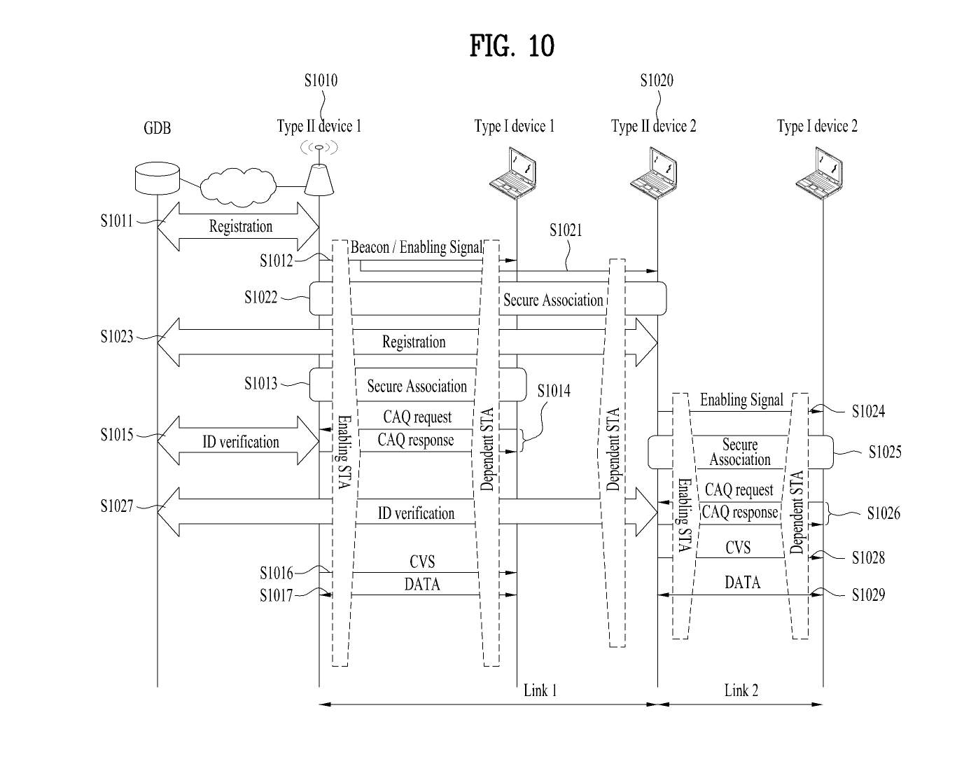

FIG. 10 is a flowchart for explaining a different example of operation of a type II device, which has no internet connection.

In the step S1011, a type II device 1 1010 accesses GDB, registers the GDB, and obtains WSM information. And then, the type II device can operate as enabling STA. Detail operations of the step S1012, S1013, S1014, and S1016 are practically identical to the operations of the step S710 to the step S740. And, in the step S1015, an operation of verifying an ID of a type I device 1 performed by the type II device 1 1010 is identical to the contents explained with reference to the step 730 of FIG. 7. For clarity, duplicated contents are omitted. In the step S1017, the type I device 1 can transceive data with the type II device 1 1010.

Meanwhile, in the step S1021, if a type II device 2 1020 receives a beacon, a secure association is performed in the step S1022 and the type II device 2 accesses the GDB in the step S1023. By doing so, the type II device 2 accesses the GDB and can obtain WSM information. Since detail explanation on the aforementioned operations are practically identical to that of the operations of the step S910 to the step S930, duplicated explanation is omitted.

Meanwhile, since detailed operations of each of the step S1025, S1026, S1027, S1028, and S1029 including an operation of transmitting an enabling signal to the type I device 2 transmitted by the type II device 2 1020 in the step S1021 are practically identical to the operations of the type II device 1 1010 and the type I device 1 in the step of S1012 to the step S1017, duplicated explanations are omitted.

The type II device 2 1020 can operate as an enabling STA after internet connection is obtained and can service the type I device 2 via a link 2. In this case, as mentioned earlier in FIG. 8, the type II device 2 1020 should consistently maintain a link 1 with the type II device 1 1010 after the internet connection is obtained. Yet, unlike the explanation of FIG. 8, such an additional operation as periodically receiving a CVS to maintain the link is not required in the example of FIG. 10. Yet, in order for the type II device 2 1020 to maintain the link 1, the type II device 2 exists within a transmission range of the type II device 1 1010 in a state that the type II device 2 is associated to the type II device 1 1010 as a dependent STA.

If an available channel has a static characteristic, GDB access may be periodically (e.g., every 24 hours) performed. In FIG. 10, if the type I device 2 does not receive internet service, the type II device 2 1020 operates as an enabling STA only and may not consistently maintain the link 1 with the type II device 1 1010. In this case, the type II device 2 1020 sets an L1 (first layer, e.g., physical layer) with a prescribed period (e.g., once in 24 hours) and may be able to receive available channel information by accessing the GDB. Hence, despite the type I device 2 loses internet connection before a GDB access period interval, it can be assumed that a previously obtained available channel is continuously valid for a prescribed period (e.g., 24 hours). Hence, the type II device 2 1020 can maintain data transmission as it is with type I devices on which ID verification has already performed. Yet, in this case, communication between the type I device and a DS may be infeasible.

In summary, device operations in accordance with each type of devices explained in the aforementioned various examples can be shown in Table 3 as follows.

TABLE 3

| | | Device |
|---|---|---|
| | operation | type |
| Enabling | (1) Access GDB and Obtain available channel | Type II |
| STA | information via registration or query | device |
| | (2) After determining operating channel, initiate | |
| | network and service dependent STA | |
| Dependent | (1) Transmit signal after receiving enabling signal | Type I |
| STA | from enabling STA to enter network | device, |
| | (2) Transmit internet packet after requesting ID | Type II |
| | verification to enabling STA and obtaining available | device |
| | channel information from enabling STA | |
| | (3) While performing BSS operation, check whether | |
| | dependent STA is within reception range of enabling | |
| | STA and whether available channel of enabling STA | |
| | is modified | |
| | (1) Transmit signal on channel on which beacon is | Type II |
| | received from enabling STA to enter network | device |
| | (2) transmit internet packet according to control of | |
| | GDB after association with enabling STA (i.e., | |
| | after association with enabling STA, firstly trans- | |
| | mitted internet packet should be used for GDB | |
| | access) | |

As shown in Table 3, if the type II device has internet connection, the type II device can operate as an enabling STA or a dependent STA. If the type II device does not have internet connection, the type II device can operate as the dependent STA only.

Determining Operating Channel

If a type II device has internet connection, the type II device can operate as enabling STA. Operating channels of type II devices different from each other can be independently determined according to each of the type II devices, respectively. In particular, the operating channels of the type II devices different from each other may be identical to each other or different from each other. Although a prescribed type II device has obtained internet connection via a different type II device, an operating channel of the prescribed type II device is not dependently determined by an operation channel of the different type II device. For instance, in FIG. 10, a type II device 2 1020 including an indirect internet connection via a type II device 1 1010 can independently determine an operating channel of the type II device 2 irrespective of the type II device 1 1010.

Meanwhile, an operating channel can be determined from an available channel list. An available channel for a prescribed device can be determined by GDB according to a geographical position, a transmit power, whether an incumbent user exists in a corresponding position, and the like of the prescribed device. Hence, available channel lists according to devices may be identical to each other or different from each other depending on a device.

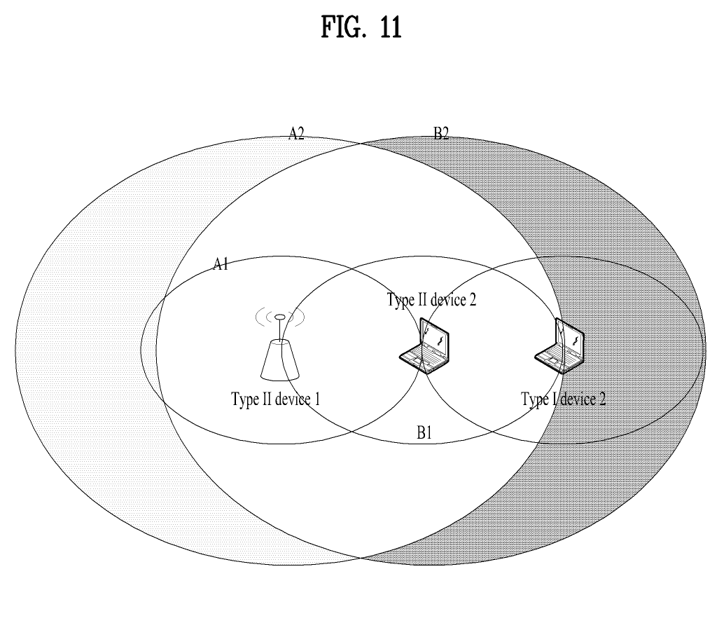

FIG. 11 is a diagram for an example of a case that an available channel set is different from each other according to a device.

Referring to an example of FIG. 11, an available channel list (i.e., WSM) of a type II device 1 is called a WSM 1 and an available channel list of a type II device 2 is called a WSM 2. If the WSM 1 includes a channel number 1, 2 and 3, the WSM 1 can be represented as {1, 2, and 3}. An available channel set for the type II device 1 is configured in consideration of transmission coverage of the type II device 1 and device(s) (e.g., a type II device 2, a type I device 1, etc.) connected with the type II device 1. Referring to the example of FIG. 11, coverage A1 is a region usable by the channel {1, 2, and 3} and coverage A2 is a region affected by interference when the channel {1, 2, and 3} are used. Similar to this, an available channel set of the type II device 2 is usable within coverage B1 and interference may affect as far as B2.

As shown in the example of FIG. 11, an example of a case that the available channel set in the A1 region is different from the available channel set in B1 region is described in the following. For instance, according to interference protection requirement in a TV band of the United States, it is required for a device operating in a TV band to protect a TV service in a specific contour. The specific contour can be called a protection contour. The protection contour can be specified according to a channel number, voltage level, a propagation curve characteristic, and the like. A device operating with more than a specific transmit power in a TV band is required to be positioned at an outside of a protection contour related to an adjacent channel and the like in a manner of being apart from the protection contour as much as a prescribed distance. This can be called a separation distance. In the example of FIG. 11, for instance, it can be assumed that a type II device 2 is positioned within a separation distance for a protection contour of a TV channel 1 and a type II device 1 is positioned at an outside of the separation distance for the protection contour of the TV channel 1.

In this case, if the type II device 1 broadcasts an enabling signal or a beacon on a TV channel 1, the type II device 2 can perform a link setup process on the TV channel 1 with the type II device 1. Subsequently, the type II device 2 may have internet connection via the type II device 1 and obtain an available channel list for the type II device 2 (i.e., WSM 2) by accessing the GDB via the internet connection. In this case, the WSM 2 does not include the TV channel 1. In particular, the WSM 1 and the WSM 2 can be represented as {1, 2, and 3} and {1, 2}, respectively according to a difference of a position and the like of the type II device 1 and the type II device 2.

Meanwhile, if a channel corresponds to an operating channel of an enabling STA, which services a type II device operating as a dependent STA, the type II device can operate on the channel although the channel is not included in the available channel of the type II device. In this case, the type II device operating as a dependent STA for a different type II device does not consider interference of a different dependent STA operating as an enabling STA and may determine an operating channel for a link operating as a dependent STA. For instance, according to an example of FIG. 11, in selecting a channel used for a link between a type II device 2 and a type II device 1, it is not necessary to consider interference of a type I device 2. This is because an operating channel of the type I device 2 is determined by the type II device 2 (i.e., an enabling STA of the type I device 2), which services the type I device 2 (i.e., a dependent STA of the type II device 2). Hence, although the WSM 2 obtained from the GDB by the type II device 2 corresponds to {2, 3}, if the type II device 1 operates on the TV channel 1, the type II device 2 can communicate with the type II device 1 using the TV channel 1.

For instance, if a type II device (e.g., a type II device 2 in FIG. 10 and FIG. 11) operates as a dependent STA for a different type II STA and operates as an enabling STA for a different dependent STA, the type II device is permitted to operate on an operating channel of the different type II device (e.g., a type II device 1 in FIG. 10 and FIG. 11) although the operating channel is not an available channel of the type II device.

Basically, it is permitted to differently determine a channel used by the type II device 2 in a link (e.g., a link 1 in FIG. 10) with the type II device 1 from a channel used in a link (e.g., a link 2 in FIG. 10) with the type I device 2. Yet, it may be required to identically determine a channel used in the link 1 and a channel used in the link 2 in the following cases.
In case that the type II device 2 does not support FDD (frequency division duplex)
In case that the type II device 2 is not equipped with a plurality of wireless transmission/reception equipments
In case that burden of the type II device is severe due to a channel change alternately using the channel 1 and the channel 2 in order for the type II device to provide an internet service to the type I device 2

The above-mentioned cases are just examples only. An identical channel for the link 1 and the link 2 may be required according to a configuration of a user or a different necessity.

In this case, the type II device operating as a dependent STA for a different type II device operating as an enabling STA can transmit information explicitly or implicitly requesting a use of an identical channel in a link with a different dependent STA operating as an enabling STA and a link for the different type II device (enabling STA) to the different type II device (enabling STA). The information can be transmitted using schemes as follows.
An available channel set (i.e., WSM) of the type II device is reported to an enabling STA
If an operating channel of the enabling STA is not permitted to the type II device, the fact is reported to the enabling STA
If an operating channel of the enabling STA is not permitted to the type II device, a change of an operating channel is requested to the enabling STA

The above-mentioned operations are just examples only. A dependent STA may make a request for a change of an operating channel to an enabling STA with a different scheme. Besides the purpose of making channels of the link 1 and the link 2 to be identical to each other, a random dependent STA may transmit the information to an enabling STA of the random dependent STA for a different purpose.

In the following description, an example of the present invention applicable to a case that a dependent STA makes a request for a change of a channel to an enabling STA is explained.

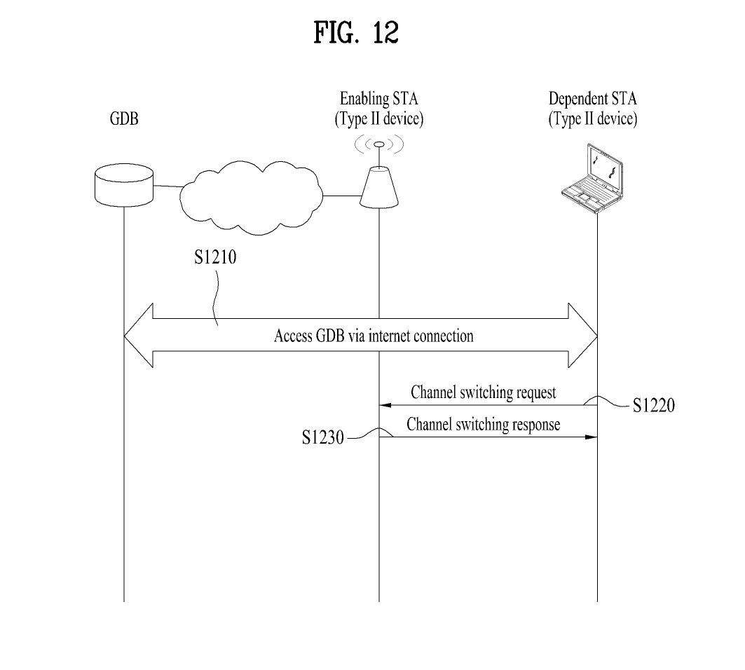

FIG. 12 is a flowchart for explaining a channel switching request/response operation.

In the step S1210, a type II device 2 obtains internet connection via a type II device 1 and can access GDB (refer to FIG. 7 or FIG. 9). In the step S1220, the type II device 2 (operating as a dependent STA) can transmit a channel switching request to the type II device 1 (operating as an enabling STA). In the step S1230, the type II device 2 can receive a channel switching response from the type II device 1.

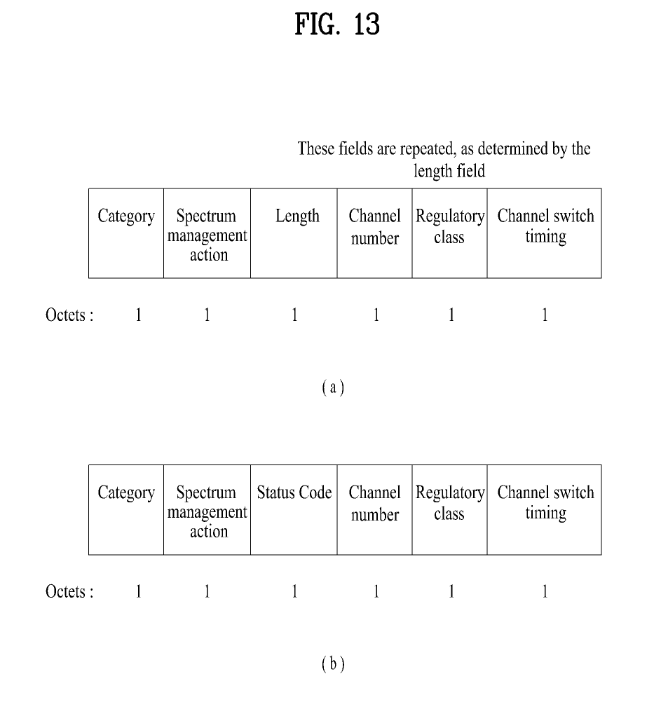

To this end, a channel switching request frame and a channel switching response frame can be newly defined. FIG. 13 (a) is a diagram for an example of a format of the channel switching request frame. FIG. 13 (b) is a diagram for an example of a format of the channel switching response frame.

As shown in FIG. 13 (a), the channel switching request frame can be used for a purpose of requesting a change of an operating channel of an enabling STA by a dependent STA. In this case, as mentioned in the foregoing examples, it is preferable that the dependent STA corresponds to a type II device.

A category field can be set to a specific value indicating that an action frame depicted in FIG. 13 corresponds to a channel switching action frame.

A spectrum management action field can be set to a specific value corresponding to a channel switching request. A following Table 4 indicates exemplary values capable of being included in the spectrum management action field and meaning of the values. In case of following the example of the Table 4, a value of the spectrum management action field shown in FIG. 13 (a) can be set to 5.

TABLE 4

| Spectrum management | |
|---|---|
| action field value | Description |
| 0 | Measurement Request |
| 1 | Measurement Report |
| 2 | TPC Request |
| 3 | TPC Report |
| 4 | Channel Switch Announcement |
| 5 | Channel Switch Request |
| 6 | Channel Switch Response |
| 7-255 | Reserved |

Subsequently, a length field can be set to a value indicating a total length of fields following the length field.

A channel number field may have 1-octet length and can be set to a value indicating a TVWS channel number, which is to be used for a link between an enabling STA and a dependent STA. A regulatory class field may have 1-octet length and can be set to a value corresponding to a regulatory class of a channel indicated by the channel number field. The regulatory class specifies a group of channels operating according to a prescribed rule and can be represented as an operating class. A channel switch timing field can be set to a value indicating information on timing on which a channel switching is to be performed.

If information on the n number of channels is included in a channel switching request frame, a set of the channel number field, the regulatory class field, and the channel switch timing field can be repeated n times. In this case, a value of the length field may have a value indicating 3×n.

The above-mentioned fields may be repeated to achieve a purpose of reporting an available channel set of a request STA in order for a response STA to select a channel to be switched in consideration of an available channel of the response STA (i.e., enabling STA) instead of determining and notifying an operating channel by the request STA (i.e., dependent STA). For instance, the dependent STA may enable the enabling STA to refer to WSM or may make a request for a channel switching to a channel preferred by the dependent STA to the enabling STA in a manner of reporting the WSM as it is or a subset of the WSM to the enabling STA. For instance, if a channel switching request frame includes information on a single channel only, this may be comprehended as the request STA determines one operating channel and informs the response STA of the operating channel. Or, if the channel switching request frame includes information on one or more channels, it may be comprehended as the request STA determines one or more candidate operating channels and informs the response STA of the candidate operating channels.

FIG. 13 (b) is a diagram for an example of a format of a channel switching response frame.

Referring to FIG. 13 (b), a category field can be set to a value corresponding to a channel switching action frame. If a spectrum management action field follows an example of Table 4, the spectrum management action field can be set to 6, which corresponds to a channel switching response.

A status code field can be set to a value indicating whether a channel switching request is succeeded. A following Table 5 indicates exemplary values capable of being included in the status code field and meaning of the values.

TABLE 5

| Status Code | |
|---|---|
| field value | Description |
| 0 | Reserved |
| 1 | Success with the requested channel |
| 2 | Request declined |
| 3 | Request not successful because requested channel |
| | is not available |
| 4 | Request not successful as one or more parameters |
| | have invalid values |
| 5 | Success with one of the multiple requested channels |
| 6-255 | Reserved |

In Table 5, if the status code field has a value of 1, 2, 3, or 4, since the channel number field, the regulatory class field, and the channel switch timing field of FIG. 13 (b) are not necessary, they may not exist. In Table 5, if the status code field corresponds to 1, since it indicates that a channel switching for a single channel has been requested and a switching to the corresponding channel is to be performed, it is not necessary to indicate a channel to which a switching is performed. If the status code field corresponds to 2, 3, or 4, it indicates a case that a request is declined or not successful. Hence, information on a channel to be switched cannot be included. Meanwhile, if the status code field corresponds to 5, when a channel switching is requested for a plurality of available channels, it indicates a case that the response STA determines an optimized operating channel among the requested channels in consideration of available channels of the response STA and the response STA informs of a switching to the determined channel.

Having received the channel switching request, if the enabling STA (response STA) judges that a current operating channel is not an available channel of a dependent channel, the response STA selects a frequency domain commonly available for both the response STA and the request STA in a manner of comparing WSM of the response STA with WSM of the switching-requested STA and may select a WLAN channel configurable within the commonly available frequency.

If there exists a frequency commonly available for the request STA and the response STA, the response STA can inform the dependent STA (request STA) of the selected WLAN channel information via a channel switching response. In particular, the channel number field, the regulatory class field, and the channel switch timing field of FIG. 13 (b) include information on an operating channel determined by the enabling STA (response STA). In this case, a value of the status code field can be set to 5.

If there does not exist the frequency commonly available for the request STA and the response STA, the enabling STA can be set to a status code 3 and the channel number field, the regulatory class field, and the channel switch timing field may not be included in the channel switching response frame of FIG. 13 (b).

In general, the aforementioned channel switching request can be performed in case that an operating channel of the enabling STA does not correspond to an available channel of the dependent STA. Yet, a case that channel information included in the channel switching request corresponds to a current operating channel of the enabling STA may occur. In this case, the enabling STA may operate in a manner of responding by including the current operating channel in a channel switching response.

According to the aforementioned examples, the dependent STA (request STA) provides information on a switching candidate channel preferred by the dependent STA to the enabling STA and the enabling STA selects a channel to be switched in consideration of the WSMs of the two STAs. As a different example, the dependent STA (request STA) may directly determine a channel to be switched (i.e., a target channel). In this case, in selecting a target channel, the dependent STA selects the target channel from the WSM of the dependent STA and may transmit information on the target channel to the enabling STA. Or, if the dependent STA obtains the WSM of the enabling STA, the dependent STA compares the WSM of the dependent STA with the WSM of the enabling STA and selects a frequency domain commonly available for the two STAs. And, the dependent STA may transmit target channel information to the enabling STA in a manner of selecting a WLAN channel configurable within a commonly available frequency as a target channel.

A scheme for the dependent STA to obtain the WSM of the enabling STA is explained in the following description. For instance, as mentioned in the foregoing description, the WSM of the enabling STA can be delivered to the dependent STA in the process of setting up a link between the dependent STA and the enabling STA. Or, the dependent STA may directly make a request for the WSM of the enabling STA to the enabling STA. In this case, the enabling STA may transmit the WSM of the enabling STA to the dependent STA in response to a request message.

If the target channel selected by the dependent STA is a channel corresponding to an operating channel of the enabling STA but the channel not corresponding to an available channel of the dependent STA, it may be comprehended as a meaning that the dependent STA makes a request for a change of the operating channel of the enabling STA to the target channel to the enabling STA. Having received the channel switching request, if the enabling STA judges that it is preferable to change the operating channel of the enabling STA to the target channel, the enabling STA accepts the request and can inform the dependent STA (request STA) of the result via a channel switching response. In this case, the status code field of FIG. 13 (b) can be set to 1 in Table 5. And, the channel number field, the regulatory class field, and the channel switch timing field may not be included in the channel switching response frame.

The aforementioned items explained in various embodiments of the present invention can be implemented in a manner of being independently applied or in a manner that two or more embodiments are simultaneously applied.

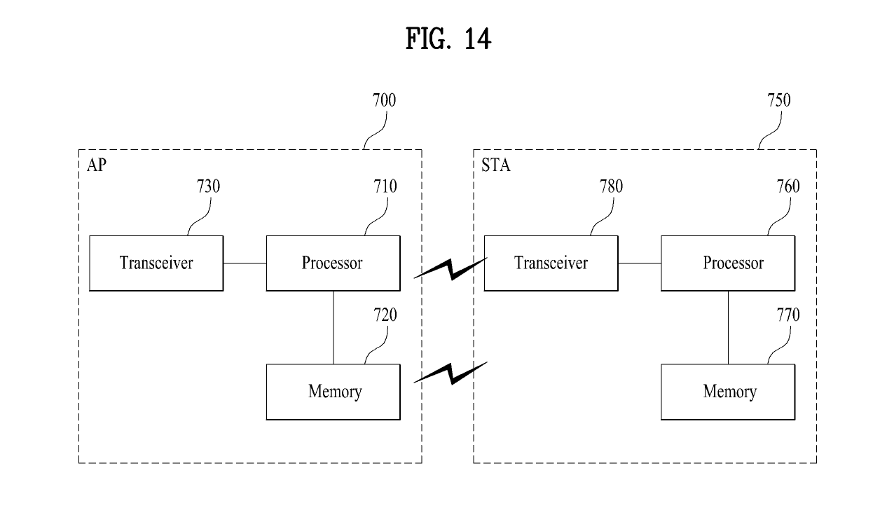

FIG. 14 is a block diagram for a configuration of a wireless device according to one embodiment of the present invention.

An AP 700 can include a processor 710, a memory 720, and a transceiver 730. An STA 750 can include a processor 760, a memory 770, and a transceiver 780. The transceiver 730/780 can transmit/receive a radio signal. For instance, the transceiver can implement a physical layer according to an IEEE 802 system. The processor 710/760 can implement a physical layer and/or a MAC layer according to an IEEE 802 system in a manner of being connected to the transceiver 730/760. The processor 710/760 can be configured to perform an operation according to the aforementioned various embodiments. And, a module for implementing the operation of the AP and the STA according to the aforementioned various embodiments of the present invention is stored in the memory 720/770 and can be executed by the processor 710/760. The memory 720/770 is included in the inside of the processor 710/760 or is installed in the external of the processor 710/760. The memory can be connected to the processor 710/760 by a well-known means.

Detail configuration of the aforementioned AP and the STA equipment can be implemented in a manner that the aforementioned items explained in various embodiments of the present invention is independently applied or two or more embodiments are simultaneously applied. For clarity, duplicated contents are omitted.

Embodiments of the present invention can be implemented using various means. For instance, embodiments of the present invention can be implemented using hardware, firmware, software and/or any combinations thereof.

In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

Detailed explanation on the preferred embodiment of the present invention disclosed as mentioned in the foregoing description is provided for those in the art to implement and execute the present invention. While the present invention has been described and illustrated herein with reference to the preferred embodiments thereof, it will be apparent to those skilled in the art that various modifications and variations can be made therein without departing from the spirit and scope of the invention. For instance, those skilled in the art can use each component described in the aforementioned embodiments in a manner of combining it with each other. Hence, the present invention may be non-limited to the aforementioned embodiments of the present invention and intends to provide a scope matched with principles and new characteristics disclosed in the present invention.

### INDUSTRIAL APPLICABILITY

Although various embodiments of the present invention are described in a manner of mainly concerning IEEE 802.11 system, the embodiments can be applied to various mobile communication systems in the same manner.

What is claimed is:

1. A method for accessing a database (DB) by a first station (STA) via a second STA, comprising:
receiving a beacon or an enabling signal from the second STA operating as an enabling STA by the first STA operating as a dependent STA;
performing an operation of setting up a link with the second STA; and
accessing the DB via the link with the second STA.

2. The method of claim 1, wherein the first STA obtains an available channel list for the first STA from the DB.

3. The method of claim 1, wherein the first STA corresponds to an STA equipped with a geo-location capability and a DB access capability.

4. The method of claim 1, wherein an internet connection is not provided to the first STA before the link with the second STA is established.

5. The method of claim 1, further comprising:
transmitting an enabling signal by the first STA to a third STA operating as a dependent STA after accessing the DB by the first STA.

6. The method of claim 5, further comprising:
receiving a channel availability query (CAQ) request by the first STA from the third STA; and
transmitting a CAQ response request by the first STA to the third STA.

7. The method of claim 5, further comprising:
transmitting a channel validity signal (CVS) by the first STA to the third STA.

8. The method of claim 5, wherein the third STA corresponds to an STA equipped with a geo-location capability and a DB access capability.

9. The method of claim 5, wherein the third STA corresponds to an STA not equipped with at least one of a geo-location capability or a DB access capability.

10. The method of claim 1, further comprising:
transmitting a channel switching request by the first STA to the second STA; and
receiving a channel switching response from the second STA.

11. The method of claim 10, wherein the channel switching request is transmitted when an operating channel of the second STA is not contained in an available channel list of the first STA.

12. The method of claim 10, wherein the channel switching request comprises information on one or more candidate channels preferred by the first STA and
wherein the channel switching response comprises information on a target channel determined by the second STA.

13. The method of claim 10, wherein the channel switching request comprises information on a target channel determined by the first STA and
wherein the channel switching response comprises information indicating whether a switching to the target channel switched by the second STA is successful.

14. A first station (STA) device accessing a database (DB) via a second STA device, comprising:
a transceiver configured to perform transmission and reception with an external device; and
a processor configured to control the first STA device containing the transceiver,
the processor configured to receive a beacon or an enabling signal from the second STA device operating as an enabling STA by the first STA device operating as a dependent STA via the transceiver, the processor configured to perform an operation of setting up a link with the second STA device, the processor configured to access the DB via the link with the second STA device.
